(19) United States
(12) Patent Application Publication
(10) Pub. No.: US 2023/0401757 A1
(43) Pub. Date: Dec. 14, 2023

(54) TARGET OBJECT LOCALIZATION

(71) Applicant: SpaceCraft, Inc., Beverly Hills, CA (US)

(72) Inventors: Ian M. Richter, Los Angleles, CA (US); Alexis R. Haraux, Seattle, WA (US)

(21) Appl. No.: 18/207,302

(22) Filed: Jun. 8, 2023

Related U.S. Application Data
(60) Provisional application No. 63/351,198, filed on Jun. 10, 2022.

(51) Int. Cl. G06T 11/00; G06T 13/80; G06V 20/60

(52) U.S. Cl. CPC G06T 11/00; G06T 13/80; G06V 20/60; G06T 2200/24

(57) ABSTRACT

In one implementation, a method of displaying virtual content is performed at a device having a display, one or more processors, and non-transitory memory. The method includes determining a geographic location of the device. The method includes determining a target object based on the geographic location of the device. The method includes detecting the target object at the geographic location of the device. The method includes, in response to detecting the target object at the geographic location of the device, displaying, on the display, virtual content associated with the target object.

### CROSS-REFERENCE TO RELATED APPLICATIONS

This application claims priority to U.S. Provisional Patent No. 63/351,198, filed on Jun. 10, 2022, which is hereby incorporated by reference in its entirety.

### TECHNICAL FIELD

The present disclosure generally relates to displaying virtual content based on geographic location.

### BACKGROUND

In various implementations, virtual content can be displayed in association with a physical target object. In various implementations, the virtual content may be localized to different geographic locations. For example, virtual content including words may be translated into different languages in different geographic locations.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates a first physical environment.

FIGS. 2A-2F illustrate the first MR environment of FIG. 1 at a series of times.

FIG. 3 illustrates a second physical environment.

FIGS. 4A-4F illustrate the second MR environment of FIG. 3 at a series of times.

FIG. 5 illustrates a flowchart representation of a method of displaying virtual content in accordance with some implementations.

FIG. 6 illustrates a block diagram of an electronic device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for displaying virtual content. In various implementations, the method is performed at a device having a display, one or more processors, and non-transitory memory. The method includes determining a geographic location of the device. The method includes determining a target object based on the geographic location of the device. The method includes detecting the target object at the geographic location of the device. The method includes, in response to detecting the target object at the geographic location of the device, displaying, on the display, virtual content associated with the target object.

In accordance with some implementations, a device includes one or more processors, a non-transitory memory, and one or more programs; the one or more programs are stored in the non-transitory memory and configured to be executed by the one or more processors. The one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### DESCRIPTION

As noted above, in various implementations, virtual content can be displayed in association with a physical target object. In various implementations, the virtual content may be localized to different geographic locations. For example, virtual content including words may be translated into different languages in different geographic locations. However, it may be beneficial that the physical target object also be localized as different geographic locations typically include different versions of the same base object, such as different currency or different electrical outlets.

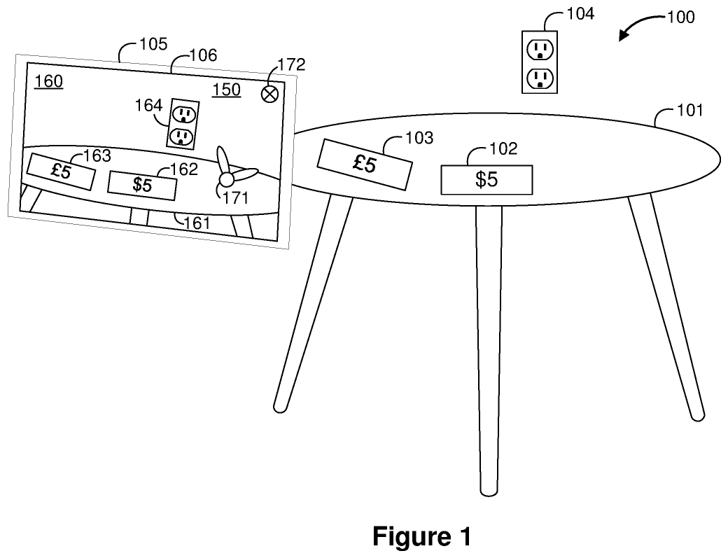

FIG. 1 illustrates a first physical environment 100 at a first geographic location. The first physical environment 100 includes a first physical table 101, a first physical five-dollar bill 102, a first physical five-pound note 103, and a physical type B outlet 104. The first physical environment 100 includes a first physical electronic device 105 (hereinafter “first device 105”) including a first display 106 via which the first device 105 displays a first mixed reality (MR) environment 150.

The first MR environment 150 includes a first physical environment representation 160 of a portion of the first physical environment 100. The first physical environment representation 160 includes a first table representation 161 of the first physical table 101, a first five-dollar bill representation 162 of the first physical five-dollar bill 102, a first five-pound note representation 163 of the first physical five-pound note 103, and a type B outlet representation 164 of the physical type B outlet 104. In various implementations, the first device 105 includes a camera directed towards a portion of the first physical environment 100 and the first physical environment representation 160 displays at least a portion of an image captured by the camera. In various implementations, the portion of the image is augmented with virtual content. For example, in FIG. 1, the first physical environment representation 160 is augmented with (and the first MR environment 150 includes) a virtual fairy 171.

The first MR environment 150 further includes a virtual close button 172 which, when selected by a user, causes the first device 105 to cease displaying the first MR environment 150.

In various implementations, a representation of a physical object may be displayed at a location on the first display 106 corresponding to the location of the physical object in the first physical environment 100. For example, in FIG. 1, the first five-dollar bill representation 162 is displayed at a location on the first display 106 corresponding to the location in the first physical environment 100 of the first physical five-dollar bill 102. Similarly, a virtual object may be displayed at a location on the first display 106 corresponding to a location in the first physical environment 100. For example, in FIG. 1, the virtual fairy 171 is displayed at a location on the first display 106 corresponding to a location in the first physical environment 100 on the first physical table 101 next to the first physical five-dollar bill 102. Because the location on the first display 106 is related to the location in the first physical environment 100 using a transform based on the pose of the first device 105, as the first device 105 moves in the first physical environment 100, the location on the first display 106 of the first five-dollar bill representation 162 changes. Similarly, as the first device 105 moves, the first device 105 corresponding changes the location on the first display 106 of the virtual fairy 171 such that it appears to maintain its location in the first physical environment 100 on the first physical table 101 next to the first physical five-dollar bill 102. A virtual object that, in response to movement of the first device 105, changes location on the first display 106 to maintain its appearance at the same location in the first physical environment 100 may be referred to as a “world-locked” virtual object. Thus, the virtual fairy 171 is a world-locked virtual object.

In contrast, a virtual object that, in response to movement of the first device 105, maintains its location on the first display 106 may be referred to as a “display-locked” virtual object. For example, in FIG. 1, the virtual close button 172 is displayed at a location on the first display 106 that does not change in response to movement of the first device 105. Thus, the virtual close button 172 is a display-locked virtual object.

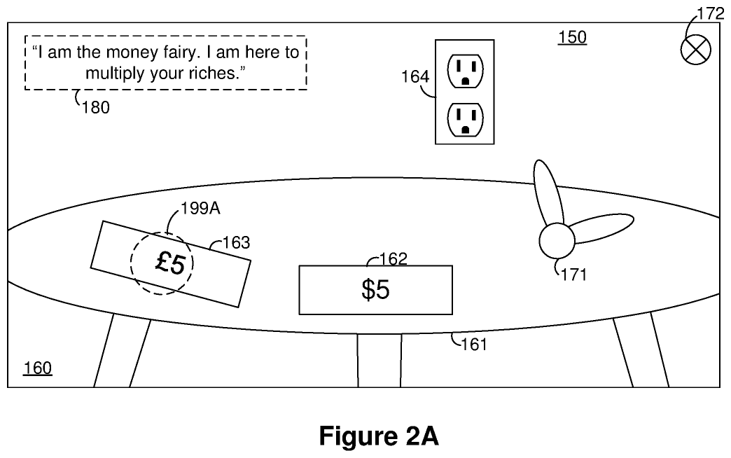

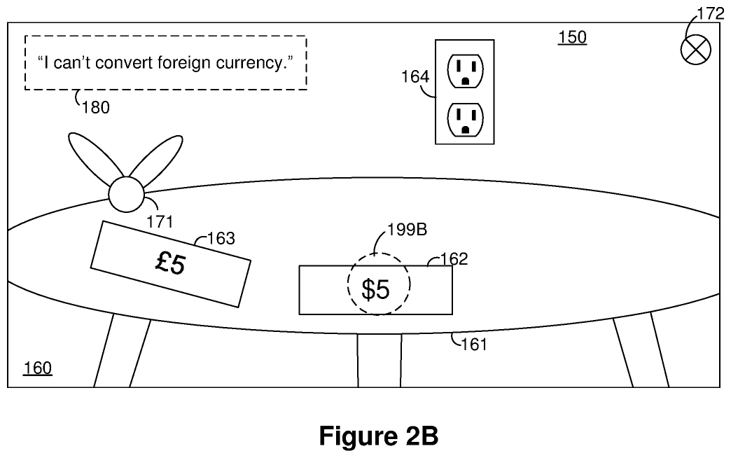

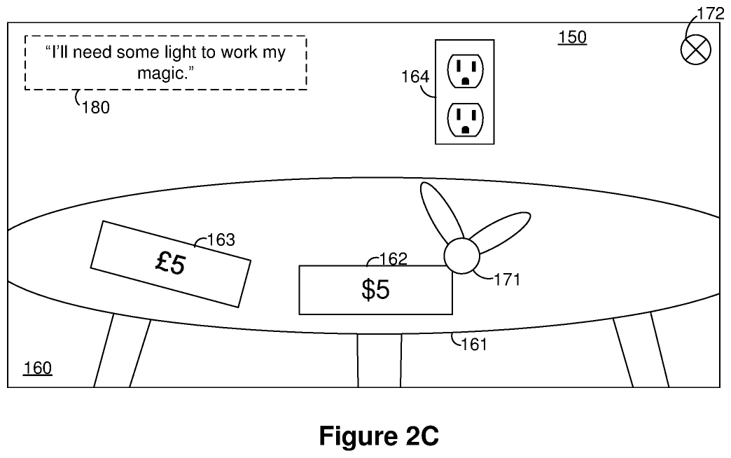

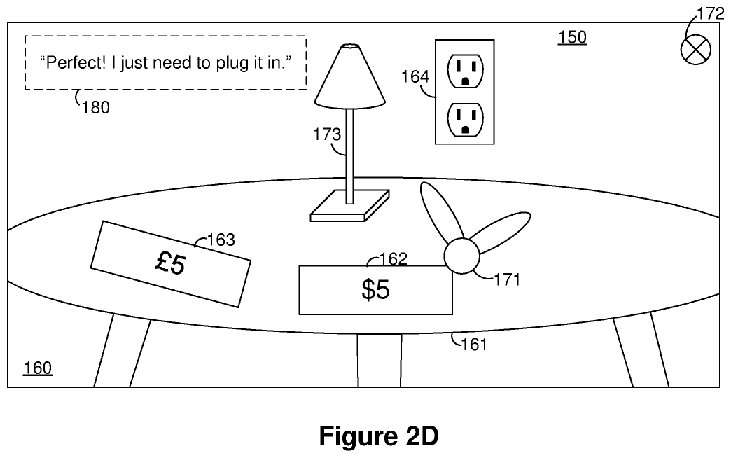

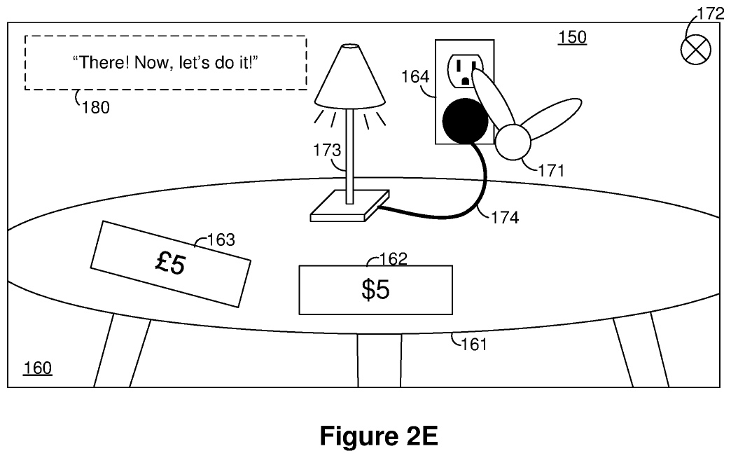

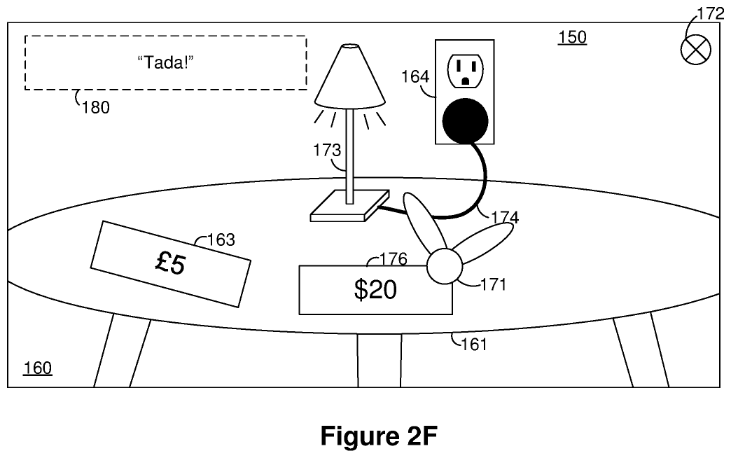

FIGS. 2A-2F illustrate the first MR environment 150 at a series of times. FIG. 2A illustrates the first MR environment 150 at a first time. At the first time, the virtual fairy 171 is at a first location in the first MR environment 150. Further, the first MR environment 150 includes a vocal indicator 180. In various implementations, the vocal indicator 180 is a display-locked virtual object displayed by the first device 105 that indicates words corresponding to audio produced by the first device 105. For example, at the first time, the first device 105 produces the sound of the virtual fairy 171 saying a first phrase of “I am the money fairy. I am here to multiply your riches.” Although FIGS. 2A-2F illustrates the vocal indicator 180 as a display-locked virtual object, in various implementations, the vocal indicator 180 is not displayed while the audio is produced by the first device 105. In various implementations, in addition to or as an alternative to saying the first phrase, the virtual fairy 171 performs a first animation, such as bowing.

At the first time, the first device 105 detects a user input 199A directed to the first physical five-pound note 103. In various implementations, the user input 199A is input by a user tapping a finger or stylus on a touch-sensitive display at the location of the first five-pound note representation 163. In various implementations, the user input 199A is input by a user performing a hand gesture in the first physical environment 100 indicating the first physical five-pound note 103, e.g., at the location of the physical five-pound note 103 or pointing at the physical five-pound note 103. In various implementations, the user input 199A is input by a user looking at the first five-pound note representation 163 and performing a gesture, e.g., an eye gesture, a hand gesture, or a vocal gesture.

FIG. 2B illustrates the first MR environment 150 at a second time subsequent to the first time. In response to detecting the user input 199A directed to the first physical five-pound note 103, the virtual fairy 171 moves to a second location in the first MR environment 150 proximate to the first five-pound note representation 163. Further, the vocal indicator 180 indicates that, at the second time, the first device 105 produces the sound of the virtual fairy 171 saying the second phrase of “I can't convert foreign currency.” In various implementations, in addition to or as an alternative to saying the second phrase, the virtual fairy 171 performs a second animation, such as shaking its head or shrugging its shoulders. At the second time, the first device 105 detects a user input 199B directed to the first physical five-dollar bill 102.

FIG. 2C illustrates the first MR environment 150 at a third time subsequent to the second time. In response to detecting the user input 199B directed to the first physical five-dollar bill 102, the virtual fairy 171 moves to a third location in the first MR environment 150 proximate to the first five-dollar bill representation 162. Further, the vocal indicator 180 indicates that, at the third time, the first device 105 produces the sound of the virtual fairy 171 saying the third phrase of “I'll need some light to work my magic.” In various implementations, in addition to or as an alternative to saying the third phrase, the virtual fairy 171 performs a third animation, such as snapping its fingers.

FIG. 2D illustrates the first MR environment 150 at a fourth time subsequent to the third time. At the fourth time, the first MR environment 150 includes a virtual lamp 173 on top of the first table representation 161. The virtual fairy 171 maintains its location at the third location in the first MR environment 150. Further, the vocal indicator 180 indicates that, at the fourth time, the first device 105 produces the sound of the virtual fairy 171 saying the fourth phrase of “Perfect! I just need to plug it in.” In various implementations, in addition to or as an alternative to saying the fourth phrase, the virtual fairy 171 performs a fourth animation, such as looking around.

FIG. 2E illustrates the first MR environment 150 at a fifth time subsequent to the fourth time. At the fifth time, the first MR environment 150 includes a virtual cord 174 that the virtual fairy 171 has plugged into the type B outlet representation 164. Thus, the virtual fairy 171 is at a fourth location in the first MR environment 150 proximate to the type B outlet representation 164. Further, the vocal indicator 180 indicates that, at the fifth time, the first device 105 produces the sound of the virtual fairy 171 saying the fifth phrase of “There! Let's do it!” In various implementations, in addition to or as an alternative to saying the fifth phrase, the virtual fairy 171 performs a fifth animation, such as rubbing its hands together.

FIG. 2F illustrates the first MR environment 150 at a sixth time subsequent to the fifth time. At the sixth time, the first MR environment 150 includes a virtual twenty-dollar bill 176 replacing the first five-dollar bill representation 162. Thus, the virtual fairy 171 is at the third location in the first MR environment 150 proximate to the virtual twenty-dollar bill 176. Further, the vocal indicator 180 indicates that, at the sixth time, the first device 105 produces the sound of the virtual fairy 171 saying the sixth phrase of “Tada!” In various implementations, in addition to or as an alternative to saying the sixth phrase, the virtual fairy 171 performs a sixth animation, such as clapping its hands.

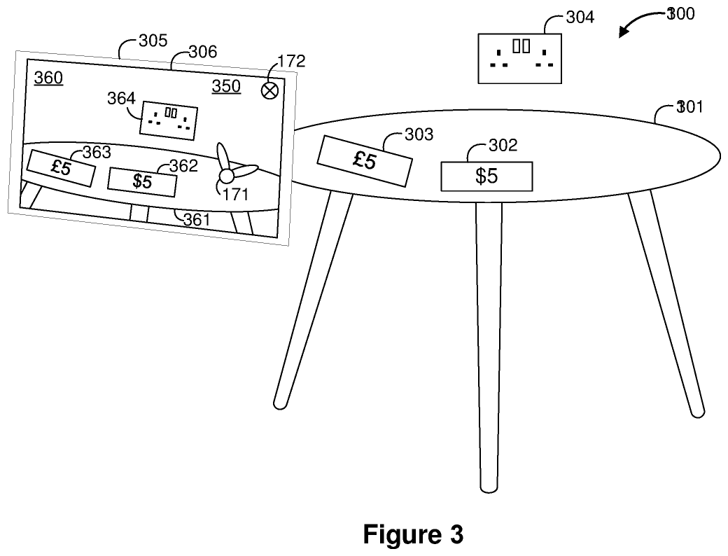

FIG. 3 illustrates a second physical environment 300 at a second geographic location different than the first geographic location. The second physical environment 300 includes a second physical table 301, a second physical five-dollar bill 302, a second physical five-pound note 303, and a physical type G outlet 304. The second physical environment 300 includes a second physical electronic device 305 (hereinafter “second device 305”) including a second display 306 via which the second device 305 displays a second mixed reality (MR) environment 350.

The second MR environment 350 includes a second physical environment representation 360 of a portion of the second physical environment 300. The second physical environment representation 360 includes a second table representation 361 of the second physical table 301, a second five-dollar bill representation 362 of the second physical five-dollar bill 302, a second five-pound note representation 363 of the second physical five-pound note 303, and a type G outlet representation 364 of the physical type G outlet 304. In various implementations, the second device 305 includes a camera directed towards a portion of the second physical environment 300 and the second physical environment representation 360 displays at least a portion of an image captured by the camera. In various implementations, the portion of the image is augmented with virtual content. For example, in FIG. 3, the first physical environment representation 360 is augmented with (and the second MR environment 350 includes) the virtual fairy 171 of FIG. 1.

The second MR environment 350 further includes the virtual close button 172 of FIG. 1 which, when selected by a user, causes the second device 305 to cease displaying the second MR environment 350.

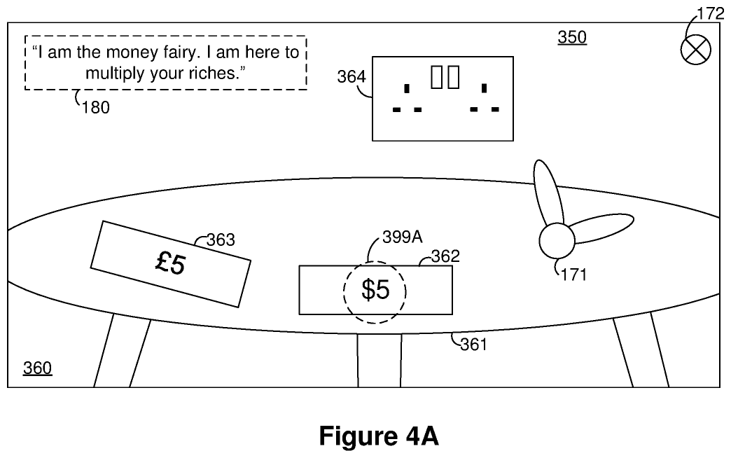

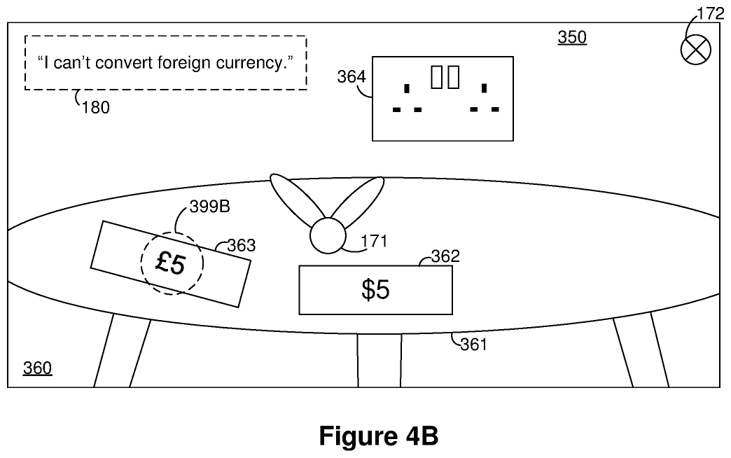

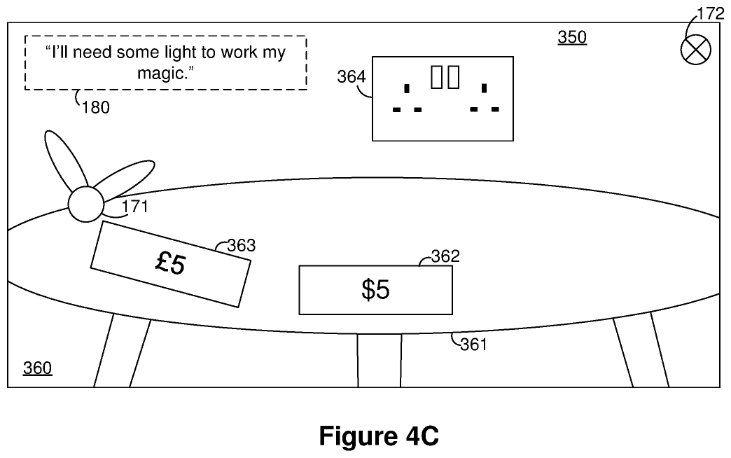

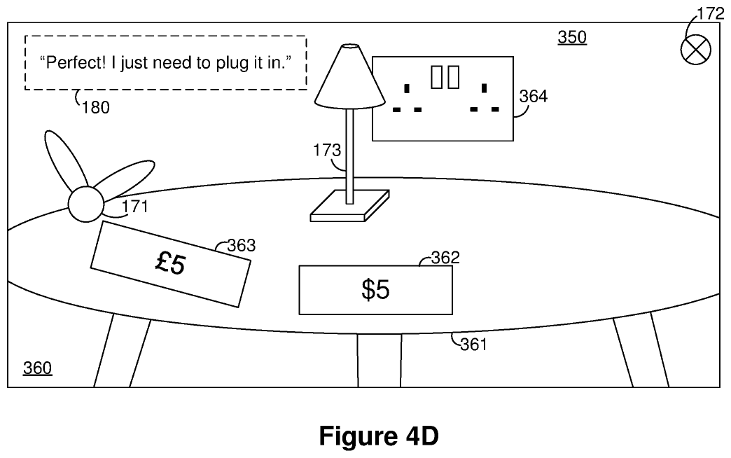

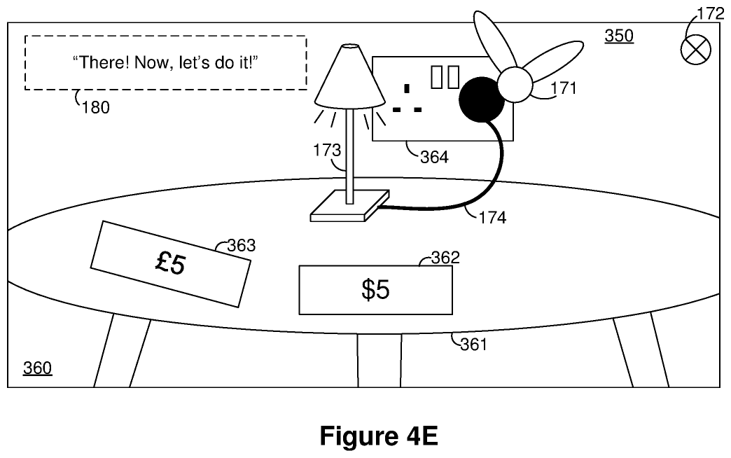

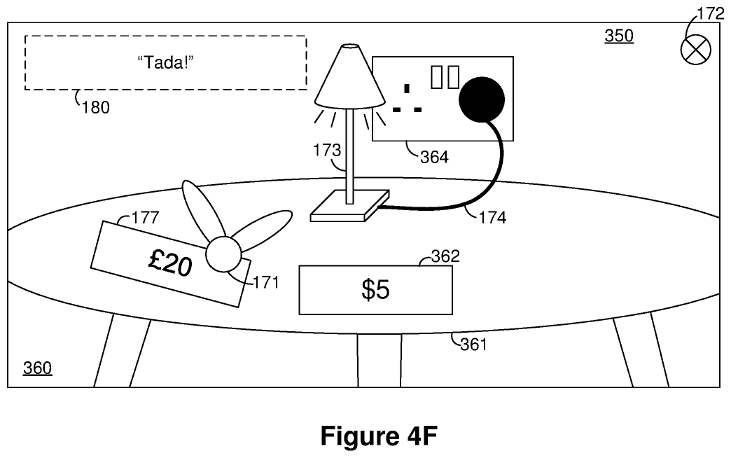

FIGS. 4A-4F illustrate the second MR environment 350 at a series of times. FIG. 4A illustrates the second MR environment 350 at a first time. At the first time, the virtual fairy 171 is at a first location in the second MR environment 350. Further, the second MR environment 350 includes the vocal indicator 180. The vocal indicator 180 indicates that, at the first time, the second device 305 produces the sound of the virtual fairy 171 saying the first phrase. Although FIGS. 4A-4F illustrates the vocal indicator 180 as a display-locked virtual object, in various implementations, the vocal indicator 180 is not displayed while the audio is produced by the second device 305. In various implementations, in addition to or as an alternative to saying the first phrase, the virtual fairy 171 performs the first animation. At the first time, the second device 305 detects a user input 399A directed to the second physical five-dollar bill 302.

FIG. 4B illustrates the second MR environment 350 at a second time subsequent to the first time. In response to detecting the user input 399A directed to the second physical five-dollar bill 103, the virtual fairy 171 moves to a second location in the second MR environment 350 proximate to the second five-dollar bill representation 362. Further, the vocal indicator 180 indicates that, at the second time, the second device 305 produces the sound of the virtual fairy 171 saying the second phrase. In various implementations, in addition to or as an alternative to saying the second phrase, the virtual fairy 171 performs the second animation. At the second time, the second device 305 detects a user input 399B directed to the second physical five-pound note 303.

FIG. 4C illustrates the second MR environment 350 at a third time subsequent to the second time. In response to detecting the user input 399B directed to the second physical five-pound note 103, the virtual fairy 171 moves to a third location in the second MR environment 350 proximate to the second five-pound note representation 363. Further, the vocal indicator 180 indicates that, at the third time, the second device 305 produces the sound of the virtual fairy 171 saying the third phrase. In various implementations, in addition to or as an alternative to saying the third phrase, the virtual fairy 171 performs the third animation.

FIG. 4D illustrates the second MR environment 350 at a fourth time subsequent to the third time. At the fourth time, the second MR environment 350 includes the virtual lamp 173 on top of the second table representation 361. The virtual fairy 171 maintains its location at the third location in the second MR environment 350. Further, the vocal indicator 180 indicates that, at the fourth time, the second device 305 produces the sound of the virtual fairy 171 saying the fourth phrase. In various implementations, in addition to or as an alternative to saying the fourth phrase, the virtual fairy 171 performs the fourth animation.

FIG. 4E illustrates the second MR environment 350 at a fifth time subsequent to the fourth time. At the fifth time, the second MR environment 350 includes the virtual cord 174 that the virtual fairy 171 has plugged into the type G outlet representation 364. Thus, the virtual fairy 171 is at a fourth location in the second MR environment 350 proximate to the type G outlet representation 364. Further, the vocal indicator 180 indicates that, at the fifth time, the second device 305 produces the sound of the virtual fairy 171 saying the fifth phrase. In various implementations, in addition to or as an alternative to saying the fifth phrase, the virtual fairy 171 performs the fifth animation.

FIG. 4F illustrates the second MR environment 350 at a sixth time subsequent to the fifth time. At the sixth time, the second MR environment 350 includes a virtual twenty-pound note 177 replacing the second five-pound note representation 363. Thus, the virtual fairy 171 is at the third location in the second MR environment 350 proximate to the virtual twenty-pound note 177. Further, the vocal indicator 180 indicates that, at the sixth time, the second device 305 produces the sound of the virtual fairy 171 saying the sixth phrase. In various implementations, in addition to or as an alternative to saying the sixth phrase, the virtual fairy 171 performs the sixth animation.

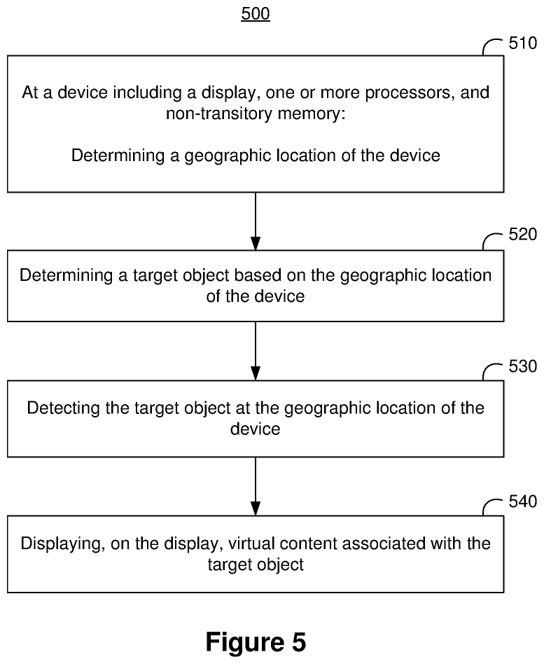

FIG. 5 is a flowchart representation of a method 500 of displaying a virtual content in accordance with some implementations. In various implementations, the method 500 is performed by a device including a display, one or more processors, and non-transitory memory. In some implementations, the method 500 is performed by processing logic, including hardware, firmware, software, or a combination thereof. In some implementations, the method 500 is performed by a processor executing instructions (e.g., code) stored in a non-transitory computer-readable medium (e.g., a memory).

The method 500 begins, in block 510, with the device determining a geographic location of the device. In various implementations, the geographic location of the device is a country or region of the device. For example, in FIG. 1, the first device 105 determines a geographic location of the first device 105 of “United States”. As another example, in FIG. 3, the second device 305 determines a geographic location of the device as “United Kingdom”. In various implementations, determining the geographic location of the device is based on a GPS signal. In various implementations, determining the geographic location of the device is based on a user input. For example, in various implementations, a user selects a geographic location of the device from a list of various geographic locations.

The method 500 continues, in block 520, with the device determining a target object based on the geographic location of the device. For example, in FIG. 2D, the first device 105 determines a target object of a type B outlet based on the geographic location of the first device 105 of “United States”. As another example, in FIG. 4D, the second device 305 determines a target object of a type G outlet based on the geographic location of the second device 305 of “United Kingdom”.

In various implementations, determining the target object includes retrieving an object model associated with the geographic location from a database storing a plurality of object models in association with a plurality of geographic locations. In various implementations, the database is stored by the device. In various implementations, the database is remote from the device. For example, in various implementations, virtual content is associated with a target object identifier, such as the text string “Electrical Outlet”. In various implementations, the database stores, in association with each of one or more target object identifiers, a plurality of object models in association with a plurality of geographic locations. In response to a query including the target object identifier and the geographic location, the database returns an object model for the target object identifier and the geographic location. For example, in response to a query including the target object identifier of “Electrical Outlet” and “United States”, the database returns an object model of a type B outlet. As another example, in response to a query including the target object identifier of “Electrical Outlet” and “United Kingdom”, the database returns an object model of a type G outlet.

The method 500 continues, in block 530, with the device detecting the target object at the geographic location of the device. In various implementations, detecting the target object includes detecting the target object based on the object model returned by the database. In various implementations, detecting the target object includes detecting the target object in an image. For example, in various implementations, the device captures, using an image sensor, an image of a physical environment in which the device is present and detects the target object in the image of the physical environment. For example, in FIG. 2D, the target object is a type B outlet and the device detects the type B outlet representation 164. As another example, in FIG. 4D, the target object is a type G outlet and the device detects the type G outlet representation 364.

In various implementations, the target object is an object having variations in various geographic locations that represent the same fundamental object. In various implementations, the target object is one of a currency, an electrical outlet, a road sign, or a hand gesture. In various implementations, the target object is a word or phrase.

The method 500 continues, in block 540, with the device, in response to detecting the target object in the geographic location, displaying, on the display, virtual content associated with the target object. For example, in FIG. 2E, in response to detecting the type B outlet representation 164, the first device 105 displays the virtual cord 174 extending from the virtual lamp 173 plugged into the type B outlet representation 164. As another example, in FIG. 4E, in response to detecting the type G outlet representation 364, the second device 305 displays the virtual cord 174 extending from the virtual lamp 173 plugged into the type G outlet representation 364.

In various implementations, displaying the virtual content includes displaying the virtual content in association with the target object. For example, in various implementations, the virtual content is displayed at least partially over a representation of the target object. As another example, in various implementations, the virtual content is displayed proximate to or indicating a representation of the target object.

In various implementations, displaying the virtual content includes displaying an animation of virtual object. For example, in FIG. 2E, the first device 105 displays an animation of the virtual fairy 171 plugging the virtual cord 174 into the type B outlet representation 164. As another example, in FIG. 4E, the second device 305 displays an animation of the virtual fairy 171 plugging the virtual cord 174 into the type G outlet representation 364.

In various implementations, the virtual content is independent of the geographic location of the device. For example, in FIG. 2E and FIG. 4E, the virtual content displayed in response to detecting, respectively, the type B outlet representation 164 and the type G outlet representation 364, is the same virtual content, an animation of the virtual fairy 171 plugging the virtual cord 174 into the detected outlet representation.

In various implementations, the virtual content is based on the geographic location of the device. For example, in FIG. 2F, the virtual content displayed in response to determining the target object as a five-dollar bill (in block 520) and detecting the first five-dollar bill representation 162 (in block 530) is the virtual twenty-dollar bill 176. In contrast, in FIG. 4F, the virtual content displayed in response to determining the target object as a five-pound note (in block 520) and detecting the second five-pound note representation 363 (in block 530) is the virtual twenty-pound note 177.

In various implementations, the database storing the plurality of object models in association with the plurality of geographic locations further stores a plurality of virtual content in association with the plurality of geographic locations. For example, in various implementations, virtual content is associated with a virtual content identifier, such as the text string “Virtual Currency”. In various implementations, the database stores, in association with each of one or more virtual object identifiers, a plurality of virtual content in association with a plurality of geographic locations. In response to a query including the virtual content identifier and the geographic location, the database returns virtual content for the virtual content identifier and the geographic location. For example, in response to a query including a target object identifier of “Local Currency” and “United States”, the database returns an object model of a five-dollar bill. In response to a query including a virtual content identifier of “Virtual Currency” and “United States”, the database returns the virtual content of the virtual twenty-dollar bill 176. As another example, in response to a query including the target object identifier of “Local Currency” and “United Kingdom”, the database returns an object model of a five-pound note. In response to a query including a virtual content identifier of “Virtual Currency” and “United States”, the database returns the virtual content of the virtual twenty-pound note 177.

In various implementations, the method 500 further includes determining a second target object based on the geographic location of the device and, in response to detecting the second target object at the geographic location of the device, displaying second virtual content associated with the second target object. For example, in FIG. 2F, the first device 105 determines, based on the geographic location of the first device 105, a target object of a type B outlet and a second target object of a five-dollar bill, detects the type B outlet representation 164 and the first five-dollar bill representation 162, and displays the virtual cord 174 and the virtual twenty-dollar bill 176. As another example, in FIG. 4F, the second device 305 determines, based on the geographic location of the second device 305, a target object of a type G outlet and a second target object of a five-pound note, detects the type G outlet representation 364 and the second five-pound note representation 363, and displays the virtual cord 174 and the virtual twenty-pound note 177.

In various implementations, the method 500 further includes determining a second target object independent of the geographic location of the device and, in response to detecting the second target object, displaying, on the display, second virtual content associated with the second target object. For example, in FIG. 2F, the first device 105 determines, based on the geographic location of the first device 105, a target object of a type B outlet and, independent of the geographic location of the first device 105, a second target object of a table, detects the type B outlet representation 164 and the first table representation 161, and displays the virtual cord 174 and the virtual lamp 173. As another example, in FIG. 4F, the second device 305 determines, based on the geographic location of the second device 305, a target object of a type G outlet and, independent of the geographic location of the second device 305, a second target object of a table, detects the type G outlet representation 364 and the second table representation 361, and displays the virtual cord 174 and the virtual lamp 173.

In various implementations, the device moves from a first physical environment at the geographic location to a second physical environment at a second geographic location. Thus, in various implementations, the second device 305 of FIG. 3 is the same as the first device 105 of FIG. 1, but at a different time. In various implementations, the method 500 includes determining a second geographic location of the device. The method 500 includes determining a second target object based on the second geographic location of the device. The method 500 includes detecting the second target object at the second geographic location of the device. The method includes, in response to detecting the second target object at the second geographic location of the device, displaying, on the display, second virtual content associated with the second target object. In various implementations, the second virtual content is the same as the first virtual content. For example, in FIG. 2D, the first device 105 displays the virtual cord 174 in response to detecting the type B outlet representation 164 at the geographic location and, in FIG. 4D, displays the same virtual cord 174 in response to detecting the type G outlet representation 364 at the second geographic location. In various implementations, the second virtual content is a localized version of the first virtual content. For example, in FIG. 2F, the first device 105 displays the virtual twenty-dollar bill 176 in response to detecting the first five-dollar bill representation 162 at the geographic location and, in FIG. 4F, displays the virtual twenty-pound note 177 in response to detecting the second five-pound note representation 363 at the second geographic location.

In various implementations, detecting the same object at different geographic locations results in the display of different virtual content. Thus, in various implementations, the method 500 includes, in response to detecting the target object at the second geographic location of the device, displaying, on the display, third virtual content associated with the target object. For example, in FIG. 2F, the first device 105 displays the virtual twenty-dollar bill 176 in response to detecting the first five-dollar bill representation 162 at the geographic location and, in FIG. 4B, displays the second animation (and plays the sound of the virtual fairy 171 saying the second phrase of “I can't convert foreign currency.”) in response to detecting the second five-dollar bill representation 362 at the second geographic location.

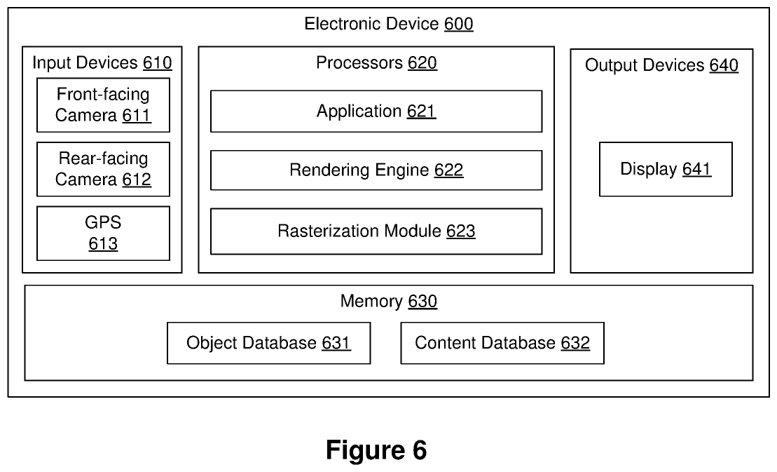

FIG. 6 illustrates a functional block diagram of an electronic device 600 in accordance with some implementations. The electronic device 600 includes one or more input devices 610, one or more processors 620, memory 630, and one or more output devices 640. The output devices 640 include a display 641. In various implementations, the electronic device 600 includes additional output devices 640, such as a speaker or vibrator for haptic feedback.

The input devices 610 include a front-facing camera 611 on the same side of the electronic device 600 as the display 641. In various implementations, the front-facing camera 611 captures images of a user. From the images of the user, a gaze location of the user can be determined. The input devices 610 include a rear-facing camera 612 on the opposite side of the electronic device 600 as the display 641. In various implementations, the rear-facing camera 612 captures images of a portion of a physical environment. The input devices 610 include a global positioning system (GPS) 613. In various implementations, data from the GPS 613 is used to determine a geographic location of the electronic device 600. In various implementations, the electronic device 600 includes additional input devices 610 such as a touchscreen interface, a mouse, a keyboard, or a microphone.

The processors 620 execute an application 621. The application 621 generates virtual content based on detecting various objects in the physical environment. In various implementations, the application 621 retrieves the virtual content from a content database 632 stored in the memory 630. In various implementations, the content database 632 stores, in association with each of one or more virtual content identifiers, a plurality of virtual content in association with a plurality of geographic locations. In response to a query from the application 621 including a virtual content identifier and a geographic location, the content database 632 returns virtual content. In various implementations, the virtual content is displayed, on the display 641, in association with a target object in the physical environment. In various implementations, the application 621 retrieves an object model of the target object from an object database 631 stored in the memory 630. In various implementations, the object database 631 stores, in association with each of one or more target object identifiers, a plurality of object models in association with a plurality of geographic locations. In response to a query from the application 621 including a target object identifier and a geographic location, the object database 631 returns an object model.

The application 621 provides coordinates for the virtual content in association with the target object to the rendering engine 622. The rendering engine 622 converts the coordinates into two-dimensional coordinates in a display coordinate system.

The rendering engine 622 provides the two-dimensional coordinates (and other primitive information) to the rasterization module 623. The rasterization module 223, which may be a graphic processing unit (GPU), generates pixel values for each pixel of the display 641 based on the primitive information. The rasterization module 623 provides the pixel values to the display 631 which displays an image comprising pixels having the pixel values.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

1. A method comprising:
at a device having a display, one or more processors, and non-transitory memory;
determining a geographic location of the device;
determining a target object based on the geographic location of the device;
detecting the target object at the geographic location of the device; and
in response to detecting the target object at the geographic location of the device, displaying, on the display, virtual content associated with the target object.

2. The method of claim 1, wherein determining the geographic location of the device is based on a GPS signal.

3. The method of claim 1, wherein determining the geographic location of the device is based on a user input.

4. The method of claim 1, wherein determining the target object includes retrieving an object model associated the geographic location from a database storing a plurality of object models in association with a plurality of geographic locations.

5. The method of claim 4, wherein detecting the target object includes detecting the target object based on the object model.

6. The method of claim 1, wherein detecting the target object includes detecting the target object in an image.

7. The method of claim 1, wherein the target object is one of a currency, an electrical outlet, a road sign, or a hand gesture.

8. The method of claim 1, wherein displaying the virtual content includes displaying the virtual content in association with the target object.

9. The method of claim 1, wherein displaying the virtual content includes displaying an animation of a virtual object.

10. The method of claim 1, wherein the virtual content is independent of the geographic location of the device.

11. The method of claim 1, wherein the virtual content is based on the geographic location of the device.

12. The method of claim 1, further comprising:
determining a second target object based on the geographic location of the device; and
in response to detecting the second target object in the geographic location of the device, displaying second virtual content associated with the second target object.

13. The method of any claim 1, further comprising:
determining a second target object independent of the geographic location of the device; and
in response to detecting the second target object, displaying, on the display, second virtual content associated with the second target object.

14. The method of claim 1, further comprising:
determining a second geographic location of the device;
determining a second target object based on the second geographic location of the device;
detecting the second target object at the second geographic location of the device; and
in response to detecting the second target object at the second geographic location of the device, displaying, on the display, second virtual content associated with the second target object.

15. The method of claim 14, wherein the second virtual content is the same as the first virtual content.

16. The method of claim 14, wherein the second virtual content is a localized version of the first virtual content.

17. The method of claim 14, further comprising:
in response to detecting the target object at the second geographic location of the device, displaying, on the display, third virtual content associated with the target object at the second geographic location of the device.

18. A device comprising:
a display;
non-transitory memory; and
one or more processors to:
determine a geographic location of the device;
determine a target object based on the geographic location of the device;
detect the target object at the geographic location of the device; and
in response to detecting the target object at the geographic location of the device, displaying, on the display, virtual content associated with the target object.

19. The device of claim 18, wherein the one or more processors are further to:
determine a second geographic location of the device;
determine a second target object based on the second geographic location of the device;
detect the second target object at the second geographic location of the device; and
in response to detecting the second target object at the second geographic location of the device, display, on the display, second virtual content associated with the second target object.

20. A non-transitory memory storing one or more programs, which, when executed by one or more processors of a device including a display, cause the device to:
determine a geographic location of the device;
determine a target object based on the geographic location of the device;
detect the target object at the geographic location of the device; and
in response to detecting the target object at the geographic location of the device, displaying, on the display, virtual content associated with the target object.
